(19) United States
(12) Patent Application Publication
(10) Pub. No.: US 2026/0048367 A1
(43) Pub. Date: Feb. 19, 2026

(54) METHOD AND AGITATION SYSTEM FOR THE MECHANICAL ACTIVATION OF ORGANIC AND/OR INORGANIC SUBSTANCES AND/OR SUBSTANCE MIXTURES IN CHEMICAL, PHARMACEUTICAL, FOOD ACCEPTABLE APPLICATIONS AND/OR IN APPLICATIONS USEFUL FOR BUILDING PURPOSES

(71) Applicant: NETZSCH Trockenmahltechnik GmbH, Selb (DE)

(72) Inventors: Ann-Christin Brandt, Kahl am Main (DE); Claus Simon, Alzenau (DE); Mario Wührl, Selb (DE)

(21) Appl. No.: 19/298,477

(22) Filed: Aug. 13, 2025

(30) Foreign Application Priority Data
Aug. 14, 2024 (DE) 102024123300.1

(51) Int. Cl. B01F 27/70; B01F 101/00; B01F 101/06; B01F 101/22

(52) U.S. Cl. CPC B01F 27/70; B01F 2101/06; B01F 2101/22; B01F 2101/2204; B01F 2215/0431; B01F 2215/045; B01F 2215/0472; B01F 2215/0477; B01F 2215/0481

(57) ABSTRACT

A method and system for mechanical activation of organic and/or inorganic substances and/or substance mixtures in chemical, pharmaceutical, food acceptable applications and/or in applications useful for building purposes, includes feeding of a substance and/or substance mixture to be activated through an inlet opening into a container which stores activation bodies, feeding a process gas stream into the container, wherein the process gas stream can support transportation of the substance and/or substance mixture to be activated, mechanically activating the substance and/or substance mixture in the container by a rotating apparatus, wherein at least one beating unit of the apparatus interacts with the activation bodies, discharging the substance and/or substance mixture activated by the activation bodies from the container through an outlet opening, wherein the substance and/or substance mixture dwells in the container for a predetermined dwell time.

### TECHNICAL FIELD

The disclosure herein relates to a method for the mechanical activation of organic and/or inorganic substances and/or substance mixtures in chemical, pharmaceutical, food acceptable applications and/or in applications useful for building purposes. Furthermore, the disclosure herein relates to an agitation system for carrying out such a method.

### BACKGROUND

In mechanochemistry, the aim is to put material into an active state through mechanical activation, in particular through shear and normal stresses, in which the material is particularly reactive. What is meant by mechanochemistry is therefore the mechanical activation of chemical reactions. Among other things, this can be attributed to destabilization of the atomic bond and changes in the crystal structures. The reactions are also favored by the comminution of the particles and the formation of new reactive surfaces. In contrast to previous reactions, mechanochemistry does not require solvents or thermal treatment, which can have a negative impact on the environment and/or on a substance and/or substance mixture to be activated mechanically.

In the prior art, for this purpose, so far, there have been used vibrating mills and planetary ball mills as well as extrusion processes. The machines used in this respect are characterized by an insufficient degree of activation and the fact that they can only be scaled up to a production scale to a limited extent. It is also currently only possible to adapt or set the geometric and process-related activation parameters to the substances or substance mixtures to be activated to a limited extent.

The majority of reactions that take place in ball mills are catalyzed. Well-known reactions here include C—N or C—C cross-coupling, cycloaddition, polymer reactions or C—H activation. A known disadvantage of catalyzers is that the recovery of the catalyst is usually difficult to achieve.

The burning of clinker is the central process in cement production. During this process, by converting CaCO3 into CaO, throughout the entire production process there is generated a considerable amount of CO2 emissions. Reducing these primary emissions by reducing the proportion of clinker in cement is a promising way of driving forward the decarbonization of the cement industry. In order to ensure that the cement still has the required properties, the use of alternative pozzolanic materials is necessary. These are also known as supplementary cementitious materials (SCMs). Possible examples of SCMs are fly ash, granulated blast furnace slag, natural pozzolans or clays. A possible alternative to thermal calcination is mechanochemical activation. In mechanochemical activation, the clay minerals are amorphized, i.e. the crystal structures of the clay minerals are broken up. This amorphization and the higher specific surface area are significantly more reactive than the original material. Contact with water causes higher chemical reactivity due to the defects created.

### SUMMARY

It is the object of the disclosure herein to provide a method for chemical, pharmaceutical, food acceptable applications and/or in applications useful for building purposes which can be carried out without solvents and can be scaled up to a sufficient production scale.

According to the disclosure herein, this object is achieved by the subject-matter disclosed herein.

According to a first aspect of the disclosure herein, there is provided a method for the mechanical activation of organic and/or inorganic substances and/or substance mixtures in chemical, pharmaceutical, food acceptable applications and/or in applications useful for building purposes. The method comprises the steps of:
feeding of a substance and/or substance mixture to be activated through an inlet opening into a container which stores activation bodies;
feeding a process gas stream into the container, wherein the process gas stream is configured to support transportation of the substance and/or substance mixture to be activated;
mechanically activating the substance and/or substance mixture in the container by a rotating apparatus, wherein at least one beating unit of the apparatus interacts with the activation bodies;
discharging the substance and/or substance mixture activated by the activation bodies from the container through an outlet opening, The substance and/or substance mixture remains in the container for a predetermined dwell time.

According to a second aspect of the disclosure herein, there is provided an agitation system for the mechanical activation of organic and/or inorganic substances and/or substance mixtures in chemical, pharmaceutical, food acceptable applications and/or in applications useful for building purposes. The agitation system is configured to perform a method according to the first aspect of the disclosure herein.

One idea underlying the disclosure herein is to provide a method for operating an agitation system for the mechanical activation of organic and/or inorganic substances and/or substance mixtures in chemical, pharmaceutical, food acceptable applications and/or in applications useful for building purposes. In doing so, the apparatus is used to mechanically activate the substances and/or substance mixtures introduced into the agitation system or into the container, in particular to accelerate the performance of mechanochemical reactions in the agitation system or to make them possible in the first place. The activation bodies inside the container are set in the desired motion for the activation reaction by the rotational movement of the at least one beating unit.

The agitation system comprises, for example, the container for holding activation bodies and a substance and/or substance mixture to be activated. The agitation system may furthermore comprise an agitation shaft mounted in the container and rotatable with respect to the container. Furthermore, the agitation system may comprise the apparatus or several of these apparatuses. In particular, the apparatus is configured for the mechanical activation of organic and/or inorganic substances and/or substance s mixtures in chemical, pharmaceutical, food acceptable applications and/or in applications useful for building purposes. The apparatus can, for example, comprise a disc-type agitation body device which is mounted on the agitation shaft so that it cannot rotate. In this respect, the at least one beating unit can have a head region with an activation surface for interacting with the activation bodies. The at least one beating unit can be attached to the disc-type agitation body device radially on the outside in relation to an axis of rotation of the disc-type agitation body device. In particular, the at least one beating unit can project radially or in a radial direction from the disc-type agitation body device in relation to the axis of rotation of the disc-type agitation body device.

The predetermined dwell time within the meaning of the disclosure herein corresponds to the time during which a defined volume of the substance and/or substance mixture dwells in the container. The dwell time can be determined experimentally using tracer substances. The process gas stream is fed from ambient air, which means that the process gas stream essentially has the chemical composition of breathing air. The substance and/or substance mixture to be activated can, in particular, be present as a solid.

For the purposes of the disclosure herein, the mechanical activation of organic and/or inorganic substances and/or substance mixtures in chemical, pharmaceutical, food acceptable applications and/or in applications useful for building purposes refers to the action of mechanical stresses or strains on the substance and/or substance mixture, so that chemical reactions, in particular reactions involving polymers, are set in motion or activated. For example, such mechanical stresses can lead to the depolymerization of polymers. In particular, during mechanical activation, there are not used any solvents or the like. This means that the mechanical activation for the mechanochemical effect is carried out in a dry container.

One advantage of the disclosure herein is that no by-products are formed. A further advantage is that the method according to the disclosure herein requires significantly less energy and/or the reaction of the substance and/or mixture of substances can be greatly accelerated.

In addition, the degree of activation can be increased and scalability and adaptability for different applications can be improved.

Advantageous embodiments and further developments are apparent from the description with reference to the figures.

According to one embodiment of the disclosure herein, the predetermined dwell time is from approximately 0.1 min (minute) to approximately 120 min, for example from approximately 3 min to approximately 90 min, preferably from approximately 10 min to approximately 55 min, in particular approximately 20 min. In this respect, there may be a direct relationship between the activation of the substance and/or substance mixture to be activated and the predetermined dwell time. This means that the predetermined dwell time can have a direct influence on a degree of activation and thus influence the reactivity.

The process gas stream can support the transportation of the substance and/or substance mixture to be activated, for example by regulating or controlling the transportation. Alternatively or additionally, the substance and/or substance mixture to be activated and the container can be tempered, for example cooled, by the process gas stream.

According to a further embodiment of the disclosure herein, the process gas stream comprises at least one of a fluidization gas stream or cooling air stream flowing into the container through the inlet opening, a cracking gas stream flowing into the container through an additional opening, and a bypass gas stream flowing into an outlet region of the container through a bypass opening. Therefore, to the container there can be fed an air flow at various points, which results in the overall process gas stream. For example, the fluidization gas stream, the cracking gas stream and the bypass gas stream may contain ambient air, i.e. essentially have the chemical composition of breathing air. Alternatively or additionally, the fluidization gas stream, the cracking gas stream and/or the bypass gas stream can essentially contain carbon dioxide, argon, nitrogen, hydrogen or another gas. In this respect, the fluidization gas stream, the cracking gas stream and the bypass gas stream can be the same gas or at least one of them can be different from the others.

According to a further embodiment of the disclosure herein, the predetermined dwell time is set by at least one from the group consisting of a throughput rate of the substance and/or substance mixture, a total quantity of the process gas stream and an application frequency of the feeding, mechanical activation and discharge steps. Therefore, the predetermined dwell time can be influenced by at least one of these three control variables.

According to a further development of the disclosure herein, the throughput rate is in a range from approximately 8 kg/h to approximately 100,000 kg/h, for example in a range from approximately 10 kg/h to approximately 600 kg/h or from approximately 1,000 kg/h to approximately 20,000 kg/h, in particular at approximately 75 kg/h. The throughput rate can be determined depending on the nominal power of the agitation system. In this manner, the dwell time can be set within an optimum range depending on the size of the agitation system. For example, for an agitation system with a rated power of around 150 KW, the throughput rate can be in the range of 10 kg/h to 600 kg/h, in particular around 75 kg/h. For an agitation system with a rated power of around 3 MW, the throughput can be in the range of 1,000 kg/h to 20,000 kg/h. For an agitation system with a nominal output of around 12 MW, the throughput can be in the range of 1,000 kg/h to 100,000 kg/h, for example. Scaling can take place according to a specific energy input and the predetermined dwell time.

According to a further embodiment of the disclosure herein, the total quantity of the process gas stream is kept almost constant and is a sum of the fluidization gas stream, the cracking gas stream and the bypass gas stream. In order to keep a constant total quantity of the process gas stream through the container, the bypass gas stream can, for example, be controlled so that it is adapted to a quantity of the substance and/or substance mixture to be activated or to the material quantity. A throughput of the substance and/or substance mixture to be activated through the container can amount to, for example, 0.8 kg/m³. The total quantity of the process gas stream can be calculated, for example, from the quotient of the throughput rate and 0.1-2.0 kg/m³.

The fluidizing gas stream, the cracked gas stream and the bypass gas stream can be supplied to and discharged from the container by a main blower unit, in that the main blower unit is arranged downstream of the outlet opening and generates a negative pressure at the outlet opening in relation to an ambient pressure, so that the fluidizing gas stream, the cracked gas stream and the bypass gas stream are sucked into the container through their respective opening. In other words, the main blower unit can be operated at negative pressure.

In addition, a blower unit can be arranged upstream of the inlet opening, the additional opening and/or the bypass opening in order to support the feeding of the fluidization gas stream, the cracking gas stream or the bypass gas stream. This means that the fluidization gas stream, the cracking gas stream and/or the bypass gas stream can each be introduced into the container via a positive pressure blower or the blower unit. Preferably, the blower unit for the fluidization gas stream can be controlled to a constant volume flow. By combining negative pressure blowers and positive pressure blowers, i.e. the main blower unit and the optionally available blower units, the required overall pressure gradient of the agitation system can be divided into energetically sensible pressure sections and the agitation system can be run or operated at the optimum operating point.

In addition, a heat exchanger can be arranged between the blower unit and the respective opening in order to temper the fluidization gas stream, the cracking gas stream or the bypass gas stream.

According to a further embodiment of the disclosure herein, the fluidization gas stream has a flow velocity in the range from approximately 0.1 m/s to approximately 10 m/s with respect to a cross-section of the container radially aligned with the agitation shaft. For example, the fluidization gas stream can be related to the cross-section radially aligned to the agitation shaft between the apparatus and a separation system, i.e. downstream of the apparatus and upstream of the separation system.

According to a further embodiment of the disclosure herein, the process gas stream at the outlet opening has a flow velocity in the range from approximately 10 m/s to approximately 30 m/s, in particular in the range from approximately 15 m/s to approximately 25 m/s.

Optionally, the agitation shaft, the apparatus and/or the at least one beating unit can be flushed by the fluidization gas stream so that the substance and/or substance mixture is transported out of the container without changing the predetermined dwell time in this respect.

According to a further embodiment of the disclosure herein, an application frequency of the steps of feeding, mechanical activation and discharging comprises in this sequence one to six passes, in particular one to three passes. In this respect, the application frequency is not limited to a specific agitation system, but can be carried out with N passes in N agitation systems connected in series or by repeated use of a single agitation system. Likewise, up to N−1 passes can be performed using a single agitation system and the remaining passes can be performed using a downstream agitation system. In this respect, the application frequency can be selected depending on the throughput rate.

According to a further embodiment of the disclosure herein, a specific energy input into the container depends on at least one from the group consisting of a peripheral speed of the at least one beating unit, a fill rate of the container, a diameter of the activation bodies and a shape of the container. The degree of activation can be directly influenced by the specific energy input. For example, the peripheral speed can be present at a radially outer end of the at least one beating unit.

The fill rate corresponds to the volume occupied by the activation bodies in relation to the total internal volume of the container. The diameter can in particular be a spherical equivalent diameter of the activation bodies. The peripheral speed and fill rate correspond to process-related activation parameters. Using a predetermined combination of various design activation parameters and various process-related activation parameters, such as those specified above, the substance to be activated and/or the substance mixture can be guided through the activation zones. In this manner there can be provided an optimal mechanochemical reaction process. The design activation parameters include, for example, different geometric designs of the disc-type agitation body device, the extension arm and/or the head region of the beating unit.

According to a further embodiment of the disclosure herein, the specific energy input is approximately 0.05 kWh/kg to approximately 6 kWh/kg, in particular approximately 0.1 kWh/kg to approximately 4 kWh/kg, particularly preferably approximately 0.7 kWh/kg.

According to a further embodiment of the disclosure herein, the at least one beating unit, in particular a radially outer end of the at least one beating unit, has a peripheral speed in the range from about 1 m/s to about 10 m/s, for example in the range from about 3.5 m/s to about 8 m/s, in particular in the range from about 4.3 m/s to about 6.5 m/s and/or in the range from about 7 m/s to about 8 m/s, particularly preferably from about 5.8 m/s. Thus, the degree of activation can be improved by centrifuging the activation bodies. For example, for an agitation system with a rated power of around 150 KW, the peripheral speed can amount to around 5.8 m/s.

According to a further embodiment of the disclosure herein, the container has a fill rate of from about 40% to about 80%, for example from about 50% to about 70%, in particular from about 55% to about 65%, particularly preferably about 60%.

According to a further embodiment of the disclosure herein, the activation bodies are essentially spherical in shape, wherein a spherical equivalent diameter of the activation bodies is in the range from about 1 mm to about 20 mm, for example in the range from about 1 mm to about 4 mm or in the range from about 4 mm to about 12 mm, in particular in the range from about 4 mm to about 8 mm. The spherical equivalent diameter can particularly preferably be around 6 mm. In this respect, the spherical equivalent diameter can be selected depending on the specific energy input required for the substance and/or substance mixture to be activated, for example 6 mm for a supplementary cementitious material, also known as SCM for short, and for an agitation system with a rated power of around 150 KW.

For example, a radially outer end of the at least one beating unit can have a distance to the container in the range of twice to ten times a diameter of the activation bodies. In this manner, the activation bodies can flow past the at least one beating unit, wherein a desired activation effect can be ensured by the at least one beating unit.

The activation bodies can be made of steel, ceramic, plastic, composite material, reactive material such as palladium, for example, and/or a combination of these materials. In addition, the activation bodies can be coated with one of the aforementioned materials or a combination thereof.

According to a further embodiment of the disclosure herein, the container has an internal temperature in the range from about 10° C. to about 400° C., for example in the range from about 20° C. to about 250° C., in particular in the range from about 100° C. to about 200° C. For example, the internal temperature can be selected depending on properties, such as a temperature and/or a quantity, of a cooling medium for cooling the container. Furthermore, the container can have a double jacket for thermal regulation of its interior with respect to an environment. In this respect, thermal regulation can be achieved with the help of water contained in the double jacket. Alternatively or additionally, the internal temperature can be selected depending on a temperature and/or the total quantity of the process gas stream.

During mechanical activation, the substance and/or substance mixture to be activated can, for example, flow through a plurality of different activation zones which are arranged one after the other in the container along a flow direction of the substance and/or substance mixture to be activated. In this respect, a number, a type and/or a design of the plurality of mutually different activation zones can be selected depending on the substance and/or substance mixture to be activated.

The direction of flow corresponds, for example, to the axis of rotation of the disc-type agitation body device or the agitation shaft. The container can have a ratio of length to diameter in the range from about 1 to about 5, in particular in the range from about 2 to about 3. Preferably, the container is cylindrical in shape. The axis of rotation of the agitation shaft can, for example, be essentially horizontally aligned in the container. In particular, the agitation shaft can be rotatably mounted centrally in the container.

In addition, the container can be stationary in relation to an environment. Optionally, the container may have a coating on its inside. The coating may contain a reactive material, for example palladium. The coating can improve the mechanochemical reaction effect in the container or make it possible at all.

For example, the plurality of different activation zones comprises at least one activation zone selected from the group of an intake zone for improved intake of the substance and/or substance mixture to be activated, a shredding zone for providing a particle size distribution suitable for activation, an activation zone for creating the greatest possible activation, a relaxation zone and a discharge zone for retaining the activation bodies and avoiding reaction processes of the activated substance and/or substance mixture. For example, the aforementioned activation zones are arranged in the sequence mentioned along the direction of flow. The plurality of mutually different activation zones may include, for example, the intake zone, the shredding zone, the activation zone and the discharge zone. In this respect, the relaxation zone can optionally be added.

In this respect, the intake zone can have at least one intake tool, wherein the intake tool is designed in particular as an intake screw, a pre-breaking element or similar. The at least one infeed tool can combine several infeed tools of the same or different types. The shredding zone or preactivation zone may in particular be configured to achieve a particle size distribution suitable for the activation, wherein, depending on the type of substance and/or substance mixture to be activated, a generation or avoidance of fines is provided. Furthermore, the activation zone can be designed to achieve the greatest possible activation by controlling a dwell time in the activation zone and a type and intensity of stress in the activation zone. The discharge zone or outlet zone can have a separation system to retain the activation bodies and prevent reaction processes of the activated substance and/or substance mixture.

Optionally, the container can have a double jacket for thermal regulation of its interior with respect to an environment. Alternatively or additionally, the agitation system may have a temperature control unit for heating or cooling the container. In this respect, the temperature control unit can be thermally coupled to the container. In this manner, the container or its interior can be heated, cooled or both heated and cooled according to the temperature required for an activation reaction.

Furthermore, depending on the activation reaction, a movement of the activation bodies that feeds into an impact stress and/or a shear stress can be adjustable.

The inlet opening and the outlet opening can, for example, be arranged on opposite sides of the container. For example, the pre-breaking element can be arranged, in particular attached, in the area of the inlet opening. Alternatively or additionally, the outlet opening can be arranged at the discharge zone. In this respect, the separation system can be installed in the outlet opening.

To support or improve the activation reaction, a reaction gas, a fluid or a solid can be added to the container via an auxiliary opening of the container.

Optionally, the agitation system may furthermore comprise a spacer bushing mounted on the agitation shaft between adjacent apparatuses. In this respect, the spacer bushing can, for example, have a passage opening that corresponds to the passage opening of the disc-type agitation body device, so that the passage opening of the spacer bushing and the passage opening of the disc-type agitation body device can form a common passage opening. In other words, the passage opening of the spacer bushing and the passage opening of the disc-type agitation body device can be arranged in alignment. This can be used to influence the air flow and consequently the control of the flow direction and flow velocity. The spacer bushing can vary in diameter and shape. In particular, the spacer bushing serves to guide the air and the substance mixture to be activated and/or substance mixture through the container.

For example, the agitation shaft can be designed in one or more parts. Alternatively or additionally, the agitation shaft can be configured as a solid shaft or a hollow shaft. Alternatively or additionally, the agitation shaft can be motor-driven. For example, the agitation shaft can be driven by a motor arranged outside the container, wherein the speed of the motor can be varied.

Optionally, the disc-type agitation body device has at least one passage opening extending in the direction of the axis of rotation. In addition, a size of the at least one passage opening can be variable, so that a permeability of the disc-type agitation body device can be varied. In this manner, a quantity of air flowing through and a substance mixture to be activated and/or substance mixture can be forced to flow around the disc-type agitation body device. In particular, the at least one passage opening can have a plurality of passage openings that are evenly distributed in a circumferential direction of the disc-type agitation body device. Thus, the substance and/or the substance mixture can pass or flow through the disc-type agitation body device without coming into contact with the at least one beating unit.

The above embodiments and further developments, where appropriate, can be combined with one another as desired. In particular, all features of the apparatus are transferable to the corresponding method, and vice versa. Further possible embodiments, further configurations and implementations of the disclosure herein also comprise, not explicitly mentioned, combinations of features of the disclosure herein described above or below with respect to the embodiment examples. In this respect, the skilled person will in particular also add individual aspects as improvements or additions to the respective basic form of the disclosure herein.

### BRIEF DESCRIPTION OF THE DRAWINGS

Hereinafter, the disclosure herein will be explained more precisely, referring to the drawings attached hereto, by examples of embodiments. In the figures:

FIG. 1 is a schematic view of an agitation system for the mechanical activation of organic and/or inorganic substances and/or substance mixtures in chemical, pharmaceutical, food acceptable applications and/or in applications useful for building purposes according to an embodiment of the disclosure herein;

FIG. 2 is a schematic sectional view of an agitation system for the mechanical activation of organic and/or inorganic substances and/or substance mixtures in chemical, pharmaceutical, food acceptable applications and/or in applications useful for building purposes according to a further embodiment of the disclosure herein; and

FIG. 3 is a schematic flow chart of a method for the mechanical activation of organic and/or inorganic substances and/or substance mixtures in chemical, pharmaceutical, food acceptable applications and/or in applications useful for building purposes according to a further embodiment of the disclosure herein.

### DETAILED DESCRIPTION

In the figures of the drawing, the same elements, features and components—unless otherwise stated—have the same reference signs.

Although specific embodiments and developments are presented and described herein, a skilled person will appreciate that a variety of alternative and/or similar embodiments may replace the specific embodiments presented and described without departing from the scope of the disclosure herein. This application is intended to cover in general all modifications or changes to the specific examples described herein.

The figures attached are intended to provide a further understanding of the embodiments of the disclosure herein and, when read along with the description, are used to explain the principles and concepts of the disclosure herein. Other example embodiments and many of the advantages will become apparent in the drawings. The drawings are to be understood merely as schematic drawings and the elements of the drawings are not necessarily shown to scale in relation to each other. Directional terminology such as “top”, “bottom”, “left”, “right”, “above”, “below”, “horizontal”, “vertical”, “front”, “back”, and similar descriptions are used only for explanatory purposes and are not intended to limit the general nature of the features shown in the figures.

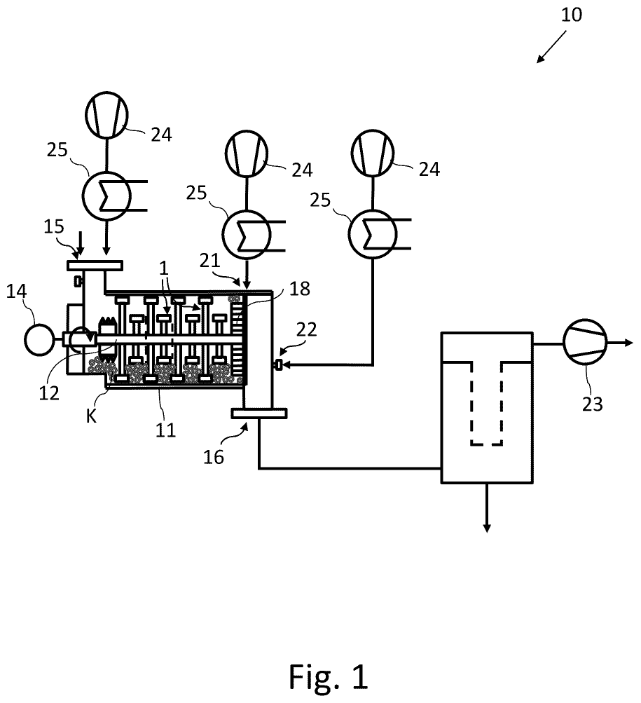

FIG. 1 shows a schematic view of an agitation system 10 for the mechanical activation of organic and/or inorganic substances and/or substance mixtures in chemical, pharmaceutical, food acceptable applications and/or in applications useful for building purposes according to an embodiment of the disclosure herein;

The agitation system 10 comprises, for example, a container 11 for receiving activation bodies K and a substance and/or substance mixture to be activated, a motor 14, an inlet opening 15, an outlet opening 16, an additional opening 21, a bypass opening 22, a main blower unit 23 and three blower units 24.

In addition, the agitation system 10 comprises a plurality of apparatuses 1 for the mechanical activation of organic and/or inorganic substances and/or substance mixtures in chemical, pharmaceutical, food acceptable applications and/or in applications useful for building purposes. The apparatus 1 can be mounted on a rotatable agitation shaft 12 in a rotationally fixed manner. The agitation shaft 12 is, for example, mounted in the container 11 and rotatable relative to the container 11.

The agitation system 10 is in particular designed to feed the substance mixture to be activated through the inlet opening 15 into the container 11, wherein the container 11 stores the activation bodies K, and to feed a process gas stream into the container 11, wherein the process gas stream is configured to support transportation of the substance and/or substance mixture to be activated and, in this respect, to cool the substance and/or substance mixture to be activated. The process gas stream may comprise a fluidization gas stream flowing through the inlet opening 15 into the container 11, a cracking gas stream flowing through the additional opening 21 into the container 11, or a bypass gas stream flowing through the bypass opening 22 into an outlet region of the container 11. The process gas stream may also comprise two or three of the aforementioned air streams.

Furthermore, the agitation system 10 is in particular designed to mechanically activate the substance and/or substance mixture in the container 11 by the rotating apparatuses 1. In this respect, at least one beating unit 3 of the apparatus 1 interacts with the activation bodies K.

In addition, the agitation system 10 is designed in particular to discharge the substance and/or substance mixture activated by the activation bodies K from the container 11 through the outlet opening 16. The substance and/or substance mixture remains in the container 11 for a predetermined dwell time.

The container 11 can have a fill rate of about 40% to about 80%, for example about 50% to about 70%, in particular about 55% to about 65%, particularly preferably about 60%.

For example, the activation bodies K can be essentially spherical in shape, wherein a spherical equivalent diameter of the activation bodies K is in the range of about 1 mm to about 20 mm, for example in the range of about 1 mm to about 4 mm or in the range of about 4 mm to about 12 mm, in particular in the range of about 4 mm to about 8 mm. The spherical equivalent diameter can particularly preferably be around 6 mm. In this respect, the spherical equivalent diameter can be selected depending on the specific energy input required for the substance and/or substance mixture to be activated, for example 6 mm for a supplementary cementitious material, also known as SCM for short, and for an agitation system with a rated power of around 150 KW.

The activation bodies K can be made of steel, ceramic, plastic, composite material, reactive material such as palladium, for example, and/or a combination of these materials. In addition, the activation bodies K can be coated with one of the aforementioned materials or a combination thereof.

The main blower unit 23 is arranged here, for example, downstream of the outlet opening 16 and can generate a negative pressure at the outlet opening 16 in relation to an ambient pressure, so that the process gas stream is sucked into the container 11 and out of the outlet opening 16. Consequently, the main blower unit 23 can be operated under negative pressure. In addition, a blower unit 24 can be arranged upstream of the inlet opening 15, the additional opening 21 and/or the bypass opening 22 in order to support the feeding of the fluidization gas stream, the cracking gas stream or the bypass gas stream. This means that the fluidization gas stream, the cracking gas stream and/or the bypass gas stream can each be introduced into the container 11 via a positive pressure blower or the blower unit 24. Preferably, the blower unit 24 for the fluidization gas stream can be controlled to a constant volume flow. By combining negative pressure blowers and positive pressure blowers, i.e. the main blower unit 23 and the optionally available blower units 24, the required overall pressure gradient of the agitation system 10 can be divided into energetically sensible pressure sections and the agitation system 10 can be run or operated at the optimum operating point.

In addition, a heat exchanger 25 can be arranged between the blower unit 24 and the respective opening 15, 21, 22 in order to temper the fluidization gas stream, the cracking gas stream or the bypass gas stream.

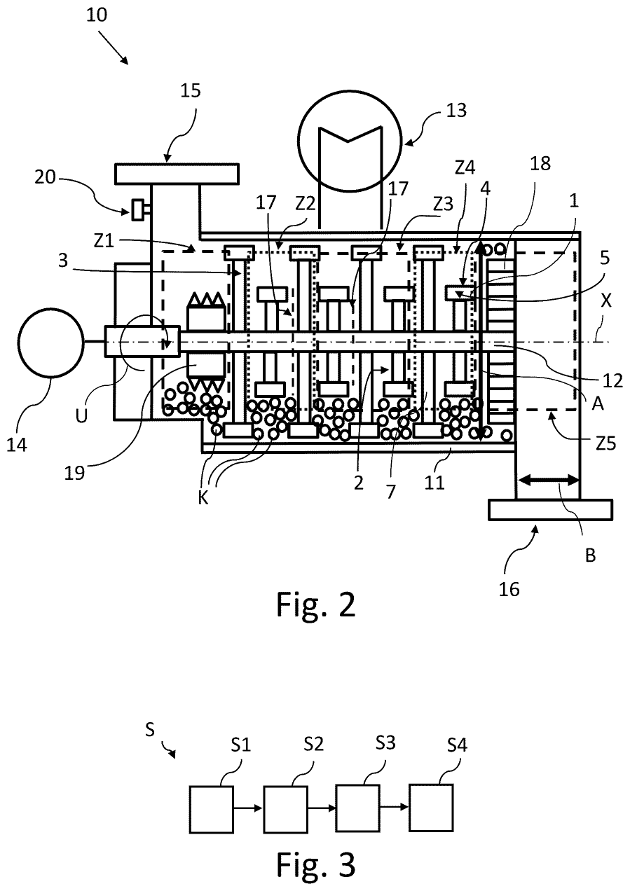

FIG. 2 shows a schematic sectional view of an agitation system 10 for the mechanical activation of organic and/or inorganic substances and/or substance mixtures in chemical, pharmaceutical, food acceptable applications and/or in applications useful for building purposes according to a further embodiment of the disclosure herein; and

The agitation system 10 comprises, for example, a container 11 for receiving activation bodies K and a substance and/or substance mixture to be activated, an agitation shaft 12, a temperature control unit 13 for heating or cooling the container 11, a motor 14, an inlet opening 15, an outlet opening 16, two spacer bushings 17, a separation system 18, a pre-breaking element 19 and an auxiliary opening 20.

In addition, the agitation system 10 comprises a plurality of apparatuses 1 for the mechanical activation of organic and/or inorganic substances and/or substance mixtures in chemical, pharmaceutical, food acceptable applications and/or in applications useful for building purposes. Each apparatus 1 comprises a disc-type agitation body device 2, which is non-rotatably mounted on the agitation shaft 12, and a plurality of beating units 3. The plurality of beating units 3 each has a head region 4 with an activation surface 5 for interacting with the activation bodies K. The plurality of beating units 3 is attached to the disc-type agitation body device 2 radially on the outside in relation to an axis of rotation X of the disc-type agitation body device 2. In particular, the plurality of beating units 3 can project radially or in a radial direction from the disc-type agitation body device 2 in relation to the axis of rotation X of the disc-type agitation body device 2.

As illustrated for example in FIG. 2, the plurality of apparatus 1 may be arranged in series on the agitation shaft 12. For example, the plurality or number of apparatuses may be 4 to 20, in particular 7 to 15, particularly preferably 8. Alternatively or additionally, the plurality or number of apparatuses 1 may depend on the diameter of the activation bodies K and a ratio of length to diameter of the container 11.

The beating units 3 of adjacent apparatuses of the plurality of apparatuses 1 can, for example, each be arranged on the agitation shaft 12 with an offset of 5° to 90° to one another. Thus, the activation surfaces 5 can be enlarged and/or the distances between the neighboring apparatuses can be reduced without the beating units 3 of the neighboring apparatuses 1 colliding with each other. Alternatively, the beating units 3 of neighboring apparatuses of the plurality of apparatuses 1 can be arranged in alignment with one another on the agitation shaft 12.

The agitation shaft 12 is mounted in the container 11 and rotatable with respect to the container 11. In this respect, a radially outer end of the respective beating unit 3 can have a distance from the container 11 in the range of twice to ten times a diameter of the activation bodies K. For example, the activation bodies K can be essentially spherical in shape, as shown schematically in FIG. 2, wherein a spherical equivalent diameter of the activation bodies K is in the range from about 1 mm to about 15 mm. The activation bodies K can be made of steel, ceramic, plastic, composite material and/or reactive material such as palladium, for example. Alternatively or additionally, the activation bodies K can be made of a combination of the aforementioned materials. In addition, the activation bodies K can be coated with one of the aforementioned materials or a combination thereof.

Optionally, the container 11 can have a double jacket for thermal regulation of its interior with respect to an environment. The temperature control unit 13 can be thermally coupled to the container 11. In this manner, the container 11 or its interior can be heated, cooled or both heated and cooled according to the temperature required for an activation reaction.

Furthermore, depending on the activation reaction, a movement of the activation bodies K that feeds into an impact stress and/or a shear stress can be adjustable.

The motor 14 may, for example, be arranged outside the container 11 and drive the agitation shaft 12. In this respect, the motor 14 can be designed and operated with variable speed.

The inlet opening 15 and the outlet opening 16 can, for example, be arranged on opposite sides of the container 11. For example, the pre-breaking element 15 can be arranged, in particular attached, in the area of the inlet opening 19. Alternatively or additionally, the separation system 18 can be installed in the outlet opening 16.

The spacer bushing 17 can be mounted between adjacent apparatuses 1 on the agitation shaft 12. The spacer bushing 17 is shown schematically in FIG. 2 as a dashed line.

To support or improve the activation reaction, a reaction gas, a fluid or a solid can be added to the container 11 via an auxiliary opening 20 of the container 11.

As shown for example in FIG. 2 by dashed or dotted rectangles, the container 11 may have a plurality of activation zones Z1, Z2, Z3, Z4, Z5 which are different from one another and which are arranged in succession along a flow direction of the substance and/or substance mixture to be activated. In this respect, a number, a type and/or a design of the plurality of mutually different activation zones Z1, Z2, Z3, Z4, Z5 can be selected depending on the substance and/or substance mixture to be activated. The direction of flow corresponds, for example, to the axis of rotation X of the disc-type agitation body device 2 or the agitation shaft 12.

The container 11 may have a length to diameter ratio in a range from about 2 to about 5. Preferably, the container 11 is cylindrical in shape. The axis of rotation of the agitation shaft 12 can, for example, be essentially horizontally aligned in the container 11. In particular, the agitation shaft 12 can be rotatably mounted centrally in the container 11. In addition, the container 11 can be stationary in relation to an environment. Optionally, the container 11 may have a coating on its inside. The coating may contain a reactive material, for example palladium. The coating can improve the mechanochemical reaction effect in the container 11 or make it possible at all.

For example, the plurality of mutually different activation zones Z1, Z2, Z3, Z4, Z5 comprises an intake zone Z1 for improved intake of the substance and/or substance mixture to be activated, a shredding zone Z2 for providing a particle size distribution suitable for activation, an activation zone Z3 for creating the greatest possible activation, an optionally relaxation zone Z4 and a discharge zone Z5 for retaining the activation bodies K and avoiding reaction processes of the activated substance and/or substance mixture. For example, the activation zones specified above are arranged in the sequence indicated along the direction of flow.

In this respect, the intake zone can have at least one intake tool, wherein the intake tool is designed in particular as an intake screw, a pre-breaking element 19 or similar. The at least one infeed tool can combine several infeed tools of the same or different types. The shredding zone or preactivation zone Z2 may in particular be configured to achieve a particle size distribution suitable for the activation, wherein, depending on the type of substance and/or substance mixture to be activated, a generation or avoidance of fines is provided. Furthermore, the activation zone Z3 can be designed to achieve the greatest possible activation by controlling a dwell time in the activation zone Z3 and a type and intensity of stress in the activation zone Z3. The discharge zone Z5 or outlet zone 18 can have a separation system to retain the activation bodies and prevent reaction processes of the activated substance and/or substance mixture.

The plurality of apparatus 1 preferably have the same features, i.e. they may be of the same design. However, the disclosure herein is not limited to similarly designed apparatuses 1 on the agitation shaft 12, but individual properties of the apparatuses 1 may differ from one another and, in particular, be adapted to requirements in the respective activation zones Z1, Z2, Z3, Z4, Z5.

For example, a plurality of apparatuses 1 for the mechanical activation of organic and/or inorganic substances and/or substance mixtures to be activated in chemical, pharmaceutical, food and/or building material applications are mounted on the agitation shaft 12, eight of which are illustrated for example. Each apparatus 1 here comprises a disc-type agitation body device 2 and four beating units 3. The four beating units 3 each have an extension arm 7 and a head region 4 with an activation surface 5 for interacting with activation bodies K. The four beating units 3 are attached to the disc-type agitation body device 2 radially on the outside in relation to an axis of rotation of the disc-type agitation body device 2.

The head region 4 can have an essentially cube-like shape. The extension arm 7 can, for example, be arranged between the disc-type agitation body device 2 and the activation surface 5. In this respect, a first end region of the extension arm 7 can be attached to the disc-type agitation body device 2 and a second end region facing away from the first end region can be coupled to the activation surface 5.

In addition, for example, a spacer bushing 17 is arranged between adjacent apparatuses 1. The spacer bushing 17 can vary in diameter and shape. In particular, the spacer bushing 17 serves to guide the air and the substance mixture to be activated and/or substance mixture through the container 11.

Here, the activation surface 5 is aligned in relation to the axis of rotation X, for example, in an angular range 8 of approximately 0° to approximately 45°. Thus, the activation surface can improve shear forces and thereby achieve higher activation with lower energy consumption. For example, the activation surface 5 is essentially flat.

For example, the agitation shaft 12 can be designed in one or more parts. Alternatively or additionally, the agitation shaft 12 can be configured as a solid shaft or a hollow shaft.

The substance to be activated and/or the substance mixture can be guided through the activation zones Z1, Z2, Z3, Z4, Z5 using a predetermined combination of various design activation parameters and various process-related activation parameters. In this manner there can be provided an optimal mechanochemical reaction process. The design activation parameters include, for example, different geometric designs of the disc-type agitation body 2 device, the extension arm 7 and/or the head region 4 of the beating unit 3. The process-related activation parameters include, for example, a peripheral speed, a fill rate of the activation bodies, a temperature in the container 11 and/or a flow of a process gas required for the mechanochemical reaction through the container.

Optionally, the head region 4 can be interchangeably connected to the beating unit 3. In this manner, the head region 4 can be replaced as required if, for example, the activation surface 5 is worn or if, for example, a different size and/or shape of the activation surface 5 is provided for the substance and/or substance mixture to be activated. This allows the head region 4 to have a modular design. Advantageously, a surface load of the activation surface 5 can thus be improved or a width of the head region 4 can be changed depending on a hardness of the substance and/or substance mixture to be activated.

In particular, the agitation system 10 is set up to carry out a method for operating an agitation system for the mechanical activation of organic and/or inorganic substances and/or substance mixtures in chemical, pharmaceutical, food and/or building material applications according to FIG. 3.

FIG. 3 shows a schematic flow chart of a method S for the mechanical activation of organic and/or inorganic substances and/or substance mixtures in chemical, pharmaceutical, food acceptable applications and/or in applications useful for building purposes according to a further embodiment of the disclosure herein.

For example, the method comprises the steps of feeding S1 of a substance and/or substance mixture to be activated, feeding S2 of a process gas stream into a container 11, mechanical activation S3 of the substance and/or substance mixture and discharge S4 of the activated substance and/or substance mixture.

In the step of feeding S1 of the substance and/or substance mixture to be activated, the substance and/or substance mixture to be activated is fed through an inlet opening 15 into the container 11, which stores activation bodies K.

In the step of feeding S2, the process gas stream is fed into the container 11, wherein the process gas stream is configured to support transportation of the substance and/or substance mixture to be activated and, in this respect, to cool the substance and/or substance mixture to be activated. The process gas stream may comprise a fluidization gas stream flowing through the inlet opening 15 into the container 11, a cracking gas stream flowing through an additional opening 21 into the container 11, or a bypass gas stream flowing through a bypass opening 22 into an outlet region of the container 11. The process gas stream may also comprise two or three of the aforementioned air streams. Therefore, to the container 11 there can be fed an air flow at various points, which results in the overall process gas stream.

In the step of mechanical activation S3 of the substance and/or substance mixture, the substance and/or substance mixture in the container 11 is mechanically activated by a rotating apparatus 1. In this respect, at least one beating unit 3 of the apparatus 1 interacts with the activation bodies K.

In the discharge step S4, the discharge of the activated substance and/or substance mixture activated by the activation bodies K is discharged from the container 11 through an outlet opening 16.

A dwell time of the substance and/or substance mixture in the container 11 is from about 1 min to about 110 min, for example from about 3 min to about 90 min, preferably from about 10 min to about 55 min, in particular about 20 min. The dwell time can be set by a throughput rate of the substance and/or substance mixture, a total quantity of the process gas stream and/or an application frequency of the steps feeding S1, S2, mechanical activation S3 and discharge S4. The dwell time can therefore be influenced by at least one of these three control variables.

In this respect, the throughput rate can be in a range from approximately 8 kg/h to approximately 100,000 kg/h, for example in a range from approximately 10 kg/h to approximately 600 kg/h or from approximately 1,000 kg/h to approximately 20,000 kg/h, in particular approximately 75 kg/h. The throughput rate can be determined depending on the nominal power of the agitation system 10. In this manner, the dwell time can be set within an optimum range depending on the size of the agitation system 10. For example, for an agitation system 10 with a nominal power of approximately 150 KW, the throughput rate can range from 10 kg/h to 600 kg/h. For an agitation system 10 with a rated power of around 3 MW, the throughput can be in the range of 1,000 kg/h to 20,000 kg/h. For an agitation system 10 with a nominal output of around 12 MW, the throughput can be in the range of 1,000 kg/h to 100,000 kg/h, for example. In this respect, scaling can take place according to a specific energy input.

Alternatively or additionally, the total quantity of the process gas stream can be kept almost constant and be a sum of the fluidization gas stream, the cracking gas stream and the bypass gas stream. In order to keep a constant total quantity of the process gas stream through the container 11, the bypass gas stream can, for example, be controlled so that it is adapted to a quantity of the substance and/or substance mixture to be activated or to the material quantity. The total quantity of the process gas stream can be calculated, for example, from the quotient of the throughput rate and 0.1-2.0 kg/m³.

The fluidizing gas stream, the cracked gas stream and the bypass gas stream can be supplied to and discharged from the container 11 by a main blower unit 23, in that the main blower unit 23 is arranged downstream of the outlet opening 16 and generates a negative pressure at the outlet opening 16 in relation to an ambient pressure, so that the fluidizing gas stream, the cracked gas stream and the bypass gas stream are sucked into the container 11 through their respective opening 15; 21; 22. In other words, the main blower unit 23 can be operated at negative pressure. In addition, a blower unit 24 can be arranged upstream of the inlet opening 15, the additional opening 21 and/or the bypass opening 22 in order to support the feeding of the fluidization gas stream, the cracking gas stream or the bypass gas stream. This means that the fluidization gas stream, the cracking gas stream and/or the bypass gas stream can each be introduced into the container 11 via a positive pressure blower or the blower unit 24. Preferably, the blower unit 24 for the fluidization gas stream can be controlled to a constant volume flow. By combining negative pressure blowers and positive pressure blowers, i.e. the main blower unit 23 and the optionally available blower units 24, the required overall pressure gradient of the agitation system 10 can be divided into energetically sensible pressure sections and the agitation system 10 can be run or operated at the optimum operating point.

Further, the fluidization gas stream may have a flow velocity in the range of about 0.1 m/s to about 10 m/s with respect to a cross-section A of the container 11 radially aligned with the agitation shaft 12 as illustrated in FIG. 2. For example, the fluidization gas stream can be related to the cross section A between the apparatus 1 and a separation system 18, which is aligned radially to the agitation shaft 12, i.e. downstream of the apparatus 1 and upstream of the separation system 18.

For example, the process gas stream at the outlet opening 16 may have a flow velocity in the range from about 10 m/s to about 30 m/s, in particular in the range from about 15 m/s to about 25 m/s. In particular, the flow velocity at the outlet opening 16 may be related to the cross-section B illustrated in FIG. 2.

Optionally, the fluidization gas stream can flow around the agitation shaft 12 and/or the apparatus 1 so that the substance and/or substance mixture is transported out of the container 11 without changing the dwell time in this respect.

An application frequency of the steps feeding S1 of a substance and/or substance mixture to be activated, feeding S2 of the process gas stream, mechanical activation S3 and discharging S4 may comprise in this sequence one to six passes, in particular one to three passes. In this respect, the application frequency is not limited to a specific agitation system, but can be carried out with N passes in N agitation systems 10 connected in series or by repeated use of a single agitation system 10. Likewise, up to N−1 passes can be performed using a single agitation system 10 and the remaining passes can be performed using a downstream agitation system. In this respect, the application frequency can be selected depending on the throughput rate.

A specific energy input into the container 11 may depend on a peripheral speed of the at least one beating unit 3, a fill rate of the container 11, a diameter of the activation bodies K and/or a shape of the container 11. The degree of activation can be directly influenced by the specific energy input. Using a predetermined combination of various design activation parameters and various process-related activation parameters, such as those specified above, the substance to be activated and/or the substance mixture can be guided through the activation zones. The design activation parameters include, for example, different geometric designs of the disc-type agitation body device, the extension arm and/or the head region of the beating unit. The specific energy input can, for example, be about 0.05 kWh/kg to about 6 kWh/kg, in particular about 0.1 kWh/kg to about 4 kWh/kg, particularly preferably about 0.7 kWh/kg.

For example, the at least one beating unit 3, in particular a radially outer end of the at least one beating unit 3, may have a peripheral speed in the range from about 1 m/s to about 10 m/s, for example in the range from about 3.5 m/s to about 8 m/s, in particular in the range from about 4.3 m/s to about 6.5 m/s and/or in the range from about 7 m/s to about 8 m/s, particularly preferably from about 5.8 m/s.

Furthermore, the container 11 can have an internal temperature in the range from approximately 10° C. to approximately 400° C., for example in the range from approximately 20° C. to approximately 250° C., in particular in the range from approximately 100° C. to approximately 200° C. For example, the internal temperature can be selected depending on properties, such as a temperature and/or a quantity, of a cooling medium for cooling the container 11. Furthermore, the container 11 can have a double jacket for thermal regulation of its interior with respect to an environment. Alternatively or additionally, the internal temperature can be selected depending on a temperature and/or the total quantity of the process gas stream.

In the preceding detailed description, various features have been summarized in one or more examples to improve the stringency of the illustration. However, it should be clear in this respect that the above description is merely illustrative and in no way limiting in nature. It is intended to cover all alternatives, modifications and equivalents of the various features and example embodiments. Many other examples will be immediately and directly obvious to a skilled person in view of the above description.

The example embodiments have been selected and described in order to best illustrate the principles underlying the invention and its possible applications in practice. As a result, skilled persons can optimally modify and use the invention and the various example embodiments thereof in relation to the intended use. In the claims as well as in the description, the terms “including” and “having” are used as neutral language terms for the corresponding terms “comprising”. Furthermore, the use of the terms “a”, “an” and “one” is not intended to fundamentally exclude a plurality of features and components described in such a manner.

### LIST OF REFERENCE SIGNS

1 apparatus
2 disc-type agitation device
3 beating unit
4 head region
5 activation surface
6 passage opening
7 extension arm
8 angular range of the activation surface
9 angle between two neighboring impact units
10 agitation system
11 container
12 agitation shaft
13 temperature control unit
14 motor
15 inlet opening
16 outlet opening
17 spacer bushing
18 separation system
19 pre-breaking element
20 auxiliary opening
21 additional opening
22 bypass opening
23 main blower unit
24 blower unit
K activation body
X axis of rotation
U circumferential direction
Z1 intake zone
Z2 shredding zone
Z3 activation zone
Z4 relaxation zone
Z5 discharge zone
S1 feeding of a substance and/or substance mixture to be activated
S2 feeding a process gas stream
S3 mechanical activation of the substance and/or substance mixture
S4 discharging the activated substance and/or substance mixture

1. A method for mechanical activation of organic and/or inorganic substances and/or substance mixtures in chemical, pharmaceutical, food acceptable applications and/or in applications useful for building purposes, the method comprising:
feeding of a substance and/or substance mixture to be activated through an inlet opening into a container which stores activation bodies;
feeding a process gas stream into the container, wherein the process gas stream is configured to support transportation of the substance and/or substance mixture to be activated;
mechanically activating the substance and/or substance mixture in the container by a rotating apparatus, wherein at least one beating unit of the apparatus interacts with the activation bodies; and
discharging the substance and/or substance mixture activated by the activation bodies from the container through an outlet opening,
wherein the substance and/or substance mixture dwells in the container for a predetermined dwell time.

2. The method according to claim 1, wherein the predetermined dwell time is from approximately 0.1 min to approximately 120 min, or from approximately 3 min to approximately 90 min, or from approximately 10 min to approximately 55 min, or approximately 20 min.

3. The method according to claim 1, wherein the process gas stream comprises at least one from a group of a fluidization gas stream flowing into the container through the inlet opening, a cracking gas stream flowing into the container through an additional opening, and a bypass gas stream flowing into an outlet region of the container through a bypass opening.

4. The method according to claim 1, wherein the predetermined dwell time is set by at least one from a group consisting of a throughput rate of the substance and/or substance mixture, a total quantity of the process gas stream and an application frequency of steps of feeding, mechanically activating and discharging.

5. The method according to claim 4, wherein the throughput rate is in a range from approximately 8 kg/h to approximately 100,000 kg/h, or in a range from approximately 10 kg/h to approximately 600 kg/h, or from approximately 1,000 kg/h to approximately 20,000 kg/h, or approximately 75 kg/h.

6. The method according to claim 4, wherein the total quantity of the process gas stream is kept almost constant and is a sum of a fluidization gas stream, a cracking gas stream and a bypass gas stream.

7. The method according to claim 3, wherein the fluidization gas stream, with respect to a cross-section of the container radially aligned with an agitation shaft, has a flow velocity in a range from approximately 0.1 m/s to approximately 10 m/s.

8. The method according to claim 1, wherein the process gas stream at the outlet opening has a flow velocity in a range from approximately 10 m/s to approximately 30 m/s, or in a range from approximately 15 m/s to approximately 25 m/s.

9. The method according to claim 1, wherein an application frequency of steps feeding of a substance and/or substance mixture to be activated, feeding of the process gas stream, mechanically activating and discharging comprises in this sequence one to six passes, or one to three passes.

10. The method according to claim 1, wherein a specific energy input into the container is dependent on at least one from a group of a peripheral speed of the at least one beating unit, a fill rate of the container, a diameter of the activation bodies and a shaping of the container.

11. The method according to claim 10, wherein the specific energy input is approximately 0.05 kWh/kg to approximately 6 kWh/kg, or approximately 0.1 kWh/kg to approximately 4 kWh/kg, or approximately 0.7 kWh/kg.

12. The method according to claim 1, wherein a radially outer end of the at least one beating unit has a peripheral speed in a range from approximately 1 m/s to approximately 10 m/s, or in a range from approximately 3.5 m/s to approximately 8 m/s, or in a range from approximately 4.3 m/s to approximately 6.5 m/s and/or in a range from approximately 7 m/s to approximately 8 m/s, or from approximately 5.8 m/s.

13. The method according to claim 1, wherein the container has a fill rate of from approximately 40% to approximately 80%, or from approximately 50% to approximately 70%, or from approximately 55% to approximately 65%, or approximately 60%.

14. The method according to claim 1, wherein the activation bodies are essentially spherical in shape, wherein a spherical equivalent diameter of the activation bodies is in a range from approximately 1 mm to approximately 20 mm, or in a range from approximately 1 mm to approximately 4 mm or in a range from approximately 4 mm to approximately 12 mm, or in the range from approximately 4 mm to approximately 8 mm.

15. The method according to claim 1, wherein the container has an internal temperature in a range from approximately 10° C. to approximately 400° C., or in a range from approximately 20° C. to approximately 250° C., or in a range from approximately 100° C. to approximately 200° C.

16. An agitation system configured to perform the method according to claim 1.
